(19) United States
(12) Patent Application Publication
(10) Pub. No.: US 2002/0067337 A1
(43) Pub. Date: Jun. 6, 2002

(54) Liquid crystal display imager and clock reduction method

(76) Inventor: Kristopher Allyn Klink, Noblesville, IN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/003,543

(22) Filed: Oct. 24, 2001

Related U.S. Application Data
(60) Provisional application No. 60/250,652, filed on Dec. 1, 2000.

(51) Int. Cl. G09G 5/00

(52) U.S. Cl. 345/156

(57) ABSTRACT

A method (700) of reducing a column clock time in a liquid crystal display includes the step (706) of driving all pixels on a given row to black by switching all pixels on the given row to a first voltage (Vcc) during a negative phase of a pixel until a row address selector (24) reaches an active video row and driving all pixels on the given row to black by switching all pixels on the given row to a second voltage (Vref) during a positive phase of the pixel until the row address selector reaches the active video row. The method may further include the step (708) of incrementing the row address selector and repeating the driving all pixels on a row having unused pixels to black until the address selector reaches a row having active video.

### RELATED APPLICATIONS

This a Non-Provisional Application of Provisional Application Serial No. 60/250,652 by Kristopher Allyn Klink filed on Dec. 1, 2000.

### FIELD OF THE INVENTION

The present invention relates to video signal processing and more particularly to a clock reduction method for a liquid crystal display imager.

### BACKGROUND OF THE INVENTION

One problem encountered in matrix imagers such as LCOS imagers is the extremely low access time allowed for single pixel access. Typically the access time is less than 25 nsec for a 1280×720 imager. The low access time may cause mis-registered pixel information.

A conventional method utilized to increase access time is to allow the imager to write data below the active picture region without refreshing column data. This creates a mirror image of the picture below the active picture until the row counter reaches the last address. The main problem with this approach is that it does not drive the unused pixels to black and will increase the stray light in the pixel drive engine. Thus, a need exists for selectively driving unused pixels to black and/or avoiding the addressing of rows having unused pixels.

The present invention is directed to solving the problems described above.

### SUMMARY OF THE INVENTION

A method to increase the write access time to an individual pixel of an imager such as an LCOS imager is described by reducing the total number of cells to be written. This is accomplished by writing unused pixels with a common voltage that is applied simultaneously to each of the unused pixels one row at a time as opposed to one pixel at a time. The voltage applied will drive unused pixels into the black state in order to prevent reflections from stray light.

More particularly, in a first aspect of the present invention, a method of reducing a column clock time in a liquid crystal display comprises driving all unused pixels on a row to black simultaneously and repeating the driving step on subsequent rows until a row with active video is detected.

In a second aspect of the present invention, a method of reducing a column clock time in a liquid crystal display comprises the steps of driving all pixels on a given row to black by switching all pixels on the given row to a first voltage during a negative phase of a pixel until a row address selector reaches an active video row and driving all pixels on the given row to black by switching all pixels on the given row to a second voltage during a positive phase of the pixel until the row address selector reaches the active video row.

In a third aspect of the present invention, a method of reducing a column clock time in a liquid crystal display comprises the steps of randomly accessing a starting row in a liquid crystal display imager having a plurality of rows and selectively addressing rows in the plurality of rows having active video and avoiding addressing rows in the plurality of rows having substantially all unused pixels.

In a fourth aspect of the present invention, a liquid crystal display imager system comprises an imager having a plurality of rows and the imager being coupled to a row address selector. The system further comprises a random access controller coupled to the row address selector that randomly accesses a row in the imager and avoids addressing rows in the imager having all unused pixels. The system may further comprise a switching mechanism that drives all unused pixels on a given row to black simultaneously if the row in the imager has all unused pixels.

### BRIEF DESCRIPTION OF THE DRAWINGS

In the drawings:

FIG. 1 is a block diagram illustrating exemplary circuitry for driving imagers of a matrix display such as a liquid crystal on silicon (LCOS) display in accordance with the present invention;

FIG. 2 is a block diagram illustrating the imager of FIG. 1 in further detail;

FIG. 3 illustrates a 1280×1024 display in accordance with the present invention;

FIG. 4 illustrates the automatic column bias circuitry in accordance with the present invention;

FIG. 5 illustrates the row switch timing of the automatic column bias circuitry of FIG. 4; and

FIG. 6 illustrates the row switch timing of the automatic column bias circuitry of FIG. 4.

FIG. 7 is a flow chart illustrating a method in accordance with the present invention.

FIG. 8 is a flow chart illustrating another method in accordance with the present invention.

### DETAILED DESCRIPTION OF THE PREFERRED EMBODIMENT

The characteristics and advantages of the present invention will become more apparent from the following description, given by way of example.

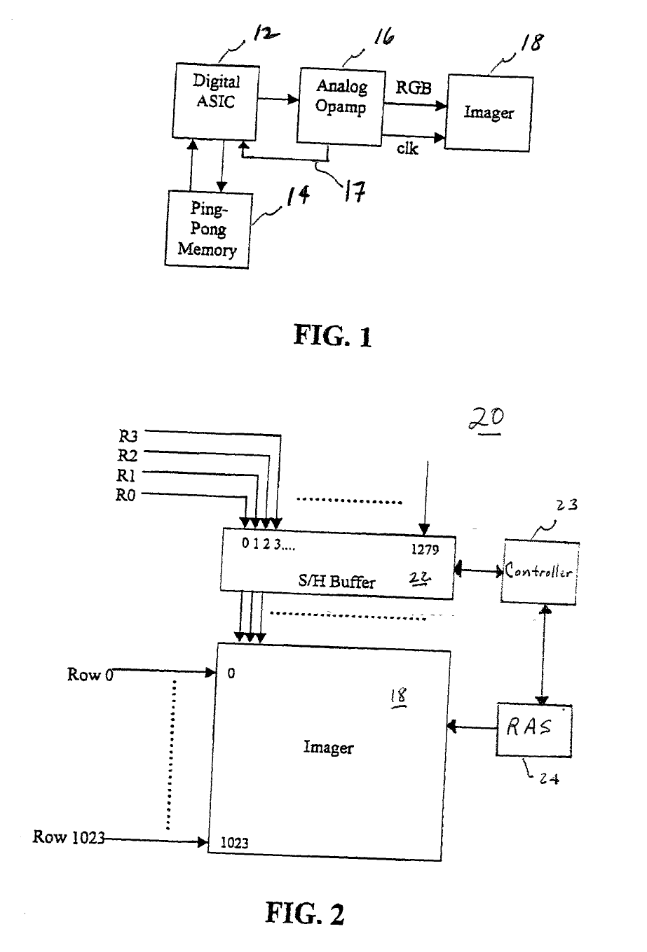

Referring to FIG. 1, a block diagram of exemplary circuitry 10 for driving an imager 18 of a matrix display such as a liquid crystal on silicon (LCOS) display is shown. The circuitry 10 includes a digital IC 12 and an analog signal IC 16. The digital IC 12 preferably converts an incoming 60 Hz frame rate to 120 Hz via a ping-pong memory architecture 14 and also performs gamma table operation through programmable look-up tables. Gamma correction is applied on the 8-bit RGB inputs to form 10-bit RGB output words. The digital IC 12 utilizes a four phase 10-bit D/A scheme per color in order to minimize the system bandwidth. In the present state of the art, four phases are needed because one phase would require too high an analog sample rate and thus, too high a slew rate. Each phase carries every fourth pixel, so the digital IC 12 preferably generates the four phases. In one embodiment, the digital IC 12 can comprise a digital-to-analog converter coupled to an analog demultiplexer. In another embodiment, the digital IC 12 could comprise a digital demultiplexer coupled to one or more digital-to-analog converters (in the case of 4 phases, four digital-to-analog converters are preferably used with each operating at ¼ speed). The analog signal IC 16 is preferably an op-amp IC that drives the imager and provides a control loop feedback signal 17 to the digital IC for D/A matching of the four-phase drivers.

Referring now to FIG. 2, a block diagram illustrating the imager system 20 comprising the imager 18 of FIG. 1 in further detail is shown. A conventional method of accessing the imager array is done by addressing each pixel by first shifting a row of analog pixel elements into a sample and hold buffer 22 (s/h buffer) and then transferring these voltages to the appropriate pixels during a row access latch. All the elements of the imager must be written at a rate of F_{clk} where:

F_{clk}=((#of pixels)(Vertical Rate)×2)/(#D/A Channels)

Twice the vertical rate is used for flicker reduction.

This constraint of F_{clk} pushes the envelope of state of the art electronics due to the high slew rates required by the opamps and drive electronics in the imager. For example, in a 1280×1024×60 Hz system, the system clock frequency is F_{clk}=39.32 Mhz.

A method to reduce the system clock frequency (F_{clk}) requirements is to use a random row access start with programmable line lengths. This scheme would allow systems that did not require the utilization of all pixels the ability to lower system clock and D/A requirements. FIG. 2 illustrates a row address selector 24 coupled to the imager 18 and a controller 23 coupled to the row address selector 24 and the s/h buffer 22 that could be programmed to randomly access a starting row in a liquid crystal display imager and selectively address rows having active video and avoiding addressing rows having all or substantially all unused pixels.

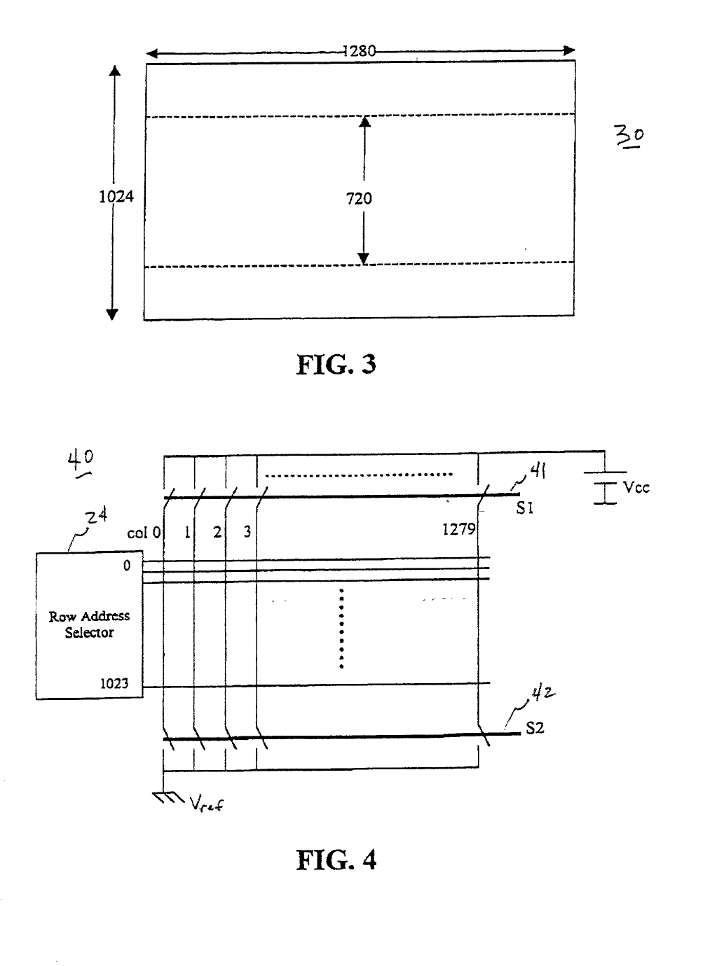

For example on a 1280×1024 imager 30, as shown in FIG. 3, a 1280×720 pixel 16×9 image could be displayed by not addressing the undesired rows of pixels and thereby reducing system clock frequency to:

F_{clk}=((1280×720)(60)×2)/(4)=27.65 Mhz.

A possible drawback to this approach is that every pixel in a matrix display (e.g., LCOS display) must be written. To overcome this drawback, a switching mechanism or demultiplexor can be used to apply a common DC voltage (corresponding to black) to all unused pixels.

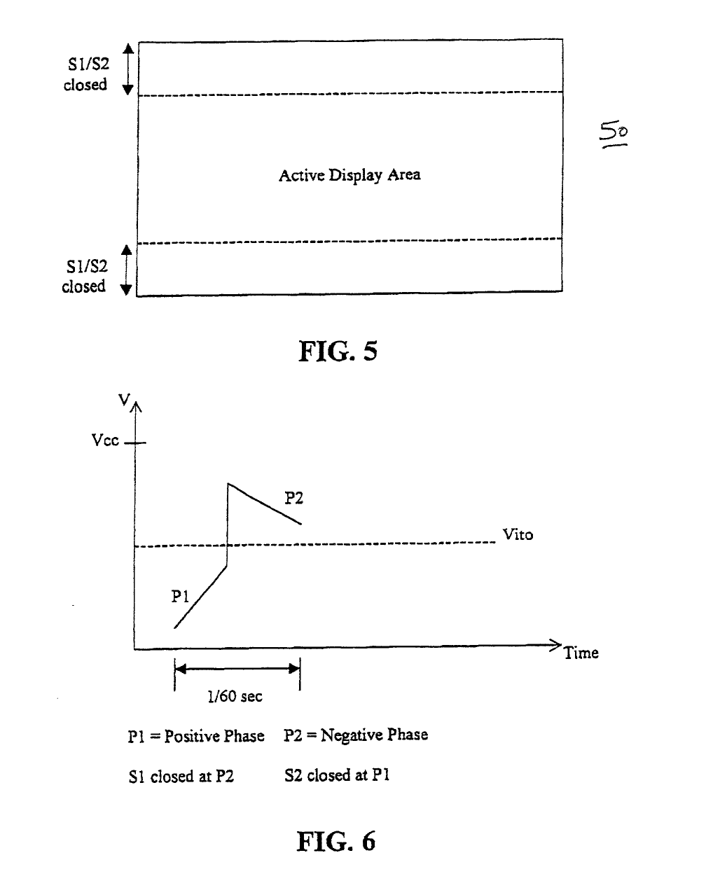

Referring now to FIG. 4, a liquid crystal display imager system 40 comprising an imager 18 having a plurality of rows and coupled to a row address selector 24 is shown. The system 40 may also comprise a random access controller as shown in FIG. 2 coupled to the row address selector that randomly accesses a row in the imager and avoids addressing rows in the imager having all unused pixels. Alternatively, the logic of the controller 24 could be embedded within the row address selector 24 of FIG. 4. As described above, the system 40 further comprises a switching mechanism (41 and 42) that drives all unused pixels on a given row to black simultaneously if the row in the imager has all unused pixels. The implementation of FIG. 4 utilizes an automatic column bias switching system for applying a common DC voltage. More specifically, FIG. 4 shows a system and method for reducing the column clock access time by closing switch S1 (41) for the negative phase of pixel writing while the row address selector 24 (RAS) increments to the desired active-video rows. All columns are written to Vcc when S1 is closed. S1 is opened at the first line of active video. This process can be reversed for the positive phase of pixel writing by closing switch S2 (42) to apply 0 vdc to each pixel that requires black to be displayed. This process is then repeated at the bottom of the imager for both phases as shown in FIGS. 5 and 6. It should be understood that in the presently preferred LCOS system to which the inventive arrangements pertain, the common plate is always at a potential of 8 volts. Each of the other plates in the array of tiny plates in the LCOS system is operated in two voltage ranges. For positive pictures, the voltage varies between 0 volts and 8 volts where 0 volts corresponds to black and 8 volts corresponds to white. For negative pictures the voltage varies between 8 volts and 16 volts where 8 volts corresponds to white and 16 volts corresponds to black. It should be understood that the present invention is not limited to these ranges or this scheme and should be limited only within contemplation of the scope of the claims.

A similar scheme could be implemented to reduce the number of rows accessed if a random access is provided for each row. An alternative method would be to speed up the row generator while accessing the black area and slow down the row generator when accessing the desired video area of an imager.

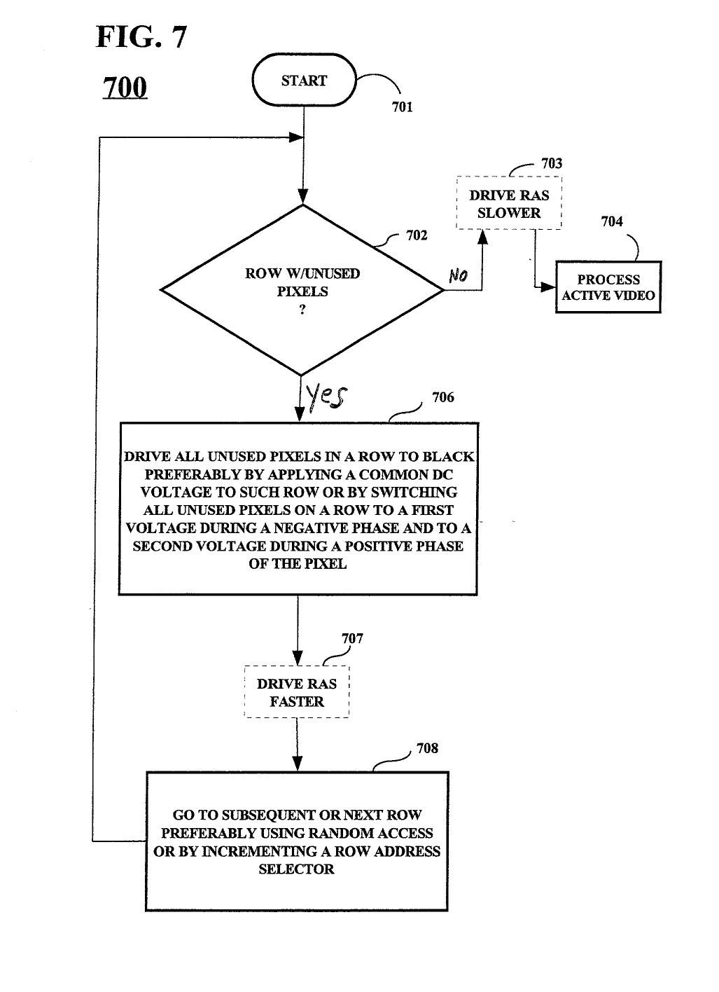

Referring to FIG. 7, a flow chart illustrating a method 700 of reducing a column clock time in a liquid crystal display is shown. The method preferably comprises the step 702 of determining if a row has all unused pixels at decision block 702. If the row has active video, then the method 700 processes the active video at step 704. If the row has all unused pixels then all unused pixels on a row are driven to black simultaneously at step 706. The method moves on to a subsequent row at step 708 and the driving step 706 is repeated until a row with active video is detected at decision block 702. In one embodiment, the step 708 can be achieved by incrementing a row access selector. The step 706 of driving the unused pixels to black can preferably be achieved by applying a common DC voltage to the row or the subsequent row. In an LCOS display this can be done by switching all pixels on the row or any subsequent row to a first voltage such as 16 volts during the negative phase of a pixel and switching all pixels on the row or any subsequent row to a second voltage (such as 0 volts) during a positive phase of the pixel until a row address selector reaches the active video row. The method may also include the optional steps of operating the row address selector at a faster speed while incrementing through rows having all pixels being driven to black at step 707 and operating the row address selector at a slower speed while incrementing through rows having active video at step 703. Preferably, the method 700 utilizes random access selection of rows, particularly for starting and selecting subsequent rows as might be done at steps 708 and at the start 701.

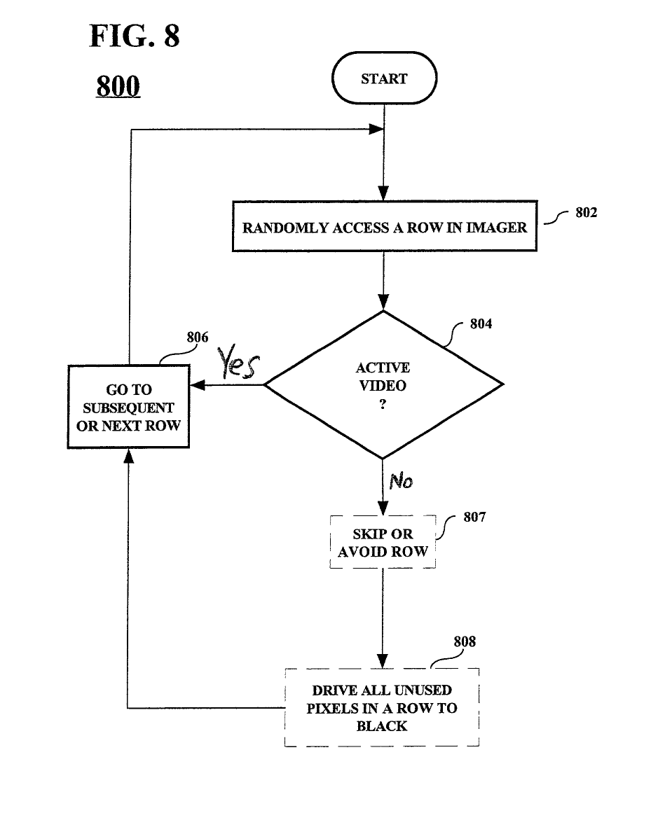

Referring to FIG. 8, a flow chart illustrating a method 800 of reducing a column clock time in a liquid crystal display is shown. The method preferably comprises the steps of randomly accessing a starting row in a liquid crystal display imager having a plurality of rows at step 802. At decision block 804, if the selectively addressed row has active video, the next row is processed as indicated by block 806. If the selectively addressed row has all or substantially all unused pixels, then the selectively addressed row can optionally be skipped or avoided at step 807 or alternatively, at step 808, the unused pixels on the selectively addressed row can be driven to black in various ways previously discussed.

Although the present invention has been described in conjunction with the embodiments disclosed herein, it should be understood that the foregoing description is intended to illustrate and not limit the scope of the invention as defined by the claims.

We claim:

1. A method of reducing a column clock time in a liquid crystal display, comprising the steps of:
determining if a row has all unused pixels on a row;
driving all unused pixels on the row to black simultaneously; and
repeating the driving step on subsequent rows until a row with active video is detected.

2. The method of claim 1, wherein the unused pixels on the row or subsequent row are driven to black by applying a common DC voltage to the row or the subsequent row.

3. The method of claim 2, wherein the steps of driving all unused pixels on the row or any subsequent row comprises the steps of switching all pixels on the row or any subsequent row to a first voltage during the negative phase of a pixel and switching all pixels on the row or any subsequent row to a second voltage during a positive phase of the pixel until a row address selector reaches the active video row.

4. The method of claim 3, wherein the row address selector operates at a faster speed while incrementing through rows having all pixels being driven to black and operates at a slower speed while incrementing through rows having active video.

5. The method of claim 3, wherein the first voltage is 16 volts and the second voltage is 0 volts.

6. The method of claim 1, wherein the method further comprises the step of randomly accessing a start of a plurality of rows in the liquid crystal display.

7. A method of reducing a column clock time in a liquid crystal display, comprising the steps of:
driving all pixels on a given row to black by switching all pixels on the given row to a first voltage during a negative phase of a pixel until a row address selector reaches an active video row; and
driving all pixels on the given row to black by switching all pixels on the given row to a second voltage during a positive phase of the pixel until the row address selector reaches the active video row.

8. The method of claim 7, wherein the method further comprises the step of incrementing the row address selector and repeating the steps of claim 1 if a subsequent row has unused pixels until the address selector reaches the active video row.

9. The method of claim 8, wherein the method further comprises the steps of repeating the steps of claim 1 when the row address selector increments to another subsequent row having unused pixels.

10. The method of claim 7, wherein the row address selector operates at a faster speed while incrementing through rows having all pixels being driven to black and operates at a slower speed while incrementing through rows having active video.

11. The method of claim 7, wherein the first voltage is 16 volts and the second voltage is 0 volts.

12. The method of claim 7, wherein the method further comprises the step of randomly accessing a start in a plurality of rows in the liquid crystal display.

13. A method of reducing a column clock time in a liquid crystal display, comprising the steps of:
randomly accessing a starting row in a liquid crystal display imager having a plurality of rows; and
selectively addressing rows in the plurality of rows having active video and avoiding addressing rows in the plurality of rows having substantially all unused pixels.

14. The method of claim 13, further comprises the steps of driving all pixels on the rows having substantially all unused pixels to black by switching all pixels on the given row to a first voltage during a negative phase of the given pixel and switching all pixels on the given row to a second voltage during a positive phase of the pixel.

15. A liquid crystal display imager system, comprises:
an imager having a plurality of rows and the imager being coupled to a row address selector; and
a random access controller coupled to the row address selector that randomly accesses a row in the imager and avoids addressing rows in the imager having all unused pixels.

16. The liquid crystal display imager system of claim 15, wherein the liquid crystal display imager system further comprises a switching mechanism that drives all unused pixels on a given row to black simultaneously if the row in the imager has all unused pixels.

17. The liquid crystal display imager system of claim 16, wherein the row address selector progresses through all rows of the imager and the switching mechanism drives all unused pixels on any row having all unused pixels to black simultaneously until a row with active video is detected.

18. The liquid crystal display imager system of claim 16, wherein the switching mechanism drives the unused pixels on the row to black by applying a common DC voltage to the row.

19. The liquid crystal display imager system of claim 16, wherein the switching mechanism switches all pixels on the row having all unused pixels to a first voltage during the negative phase of a pixel and switches all pixels on the row having all unused pixels to a second voltage during a positive phase of the pixel until the row address selector reaches an active video row.

20. The liquid crystal display imager system of claim 16, wherein the row address selector operates at a faster speed while incrementing through rows having all pixels being driven to black and operates at a slower speed while incrementing through rows having active video.

21. The liquid crystal display imager system of claim 15 wherein the system further comprises a sample and hold circuit coupled to the random access controller to enable the random access controller to detect rows having all unused pixels.

22. The liquid crystal display imager system of claim 15, wherein the system is for a liquid crystal on silicon crystal display.
